(19) United States
(12) Patent Application Publication
(10) Pub. No.: US 2025/0336629 A1
(43) Pub. Date: Oct. 30, 2025

(54) MOVABLE CARRIER STRUCTURE FOR ELECTRICAL DEVICE

(71) Applicant: Sensata Technologies, Inc., Attleboro, MA (US)

(72) Inventors: Calvin S. Reuter, Cumberland, RI (US); Cory Bousquet, Uxbridge, MA (US); Emily Haidemenos, Ridgeland, SC (US)

(73) Assignee: Sensata Technologies, Inc., Attleboro, MA (US)

(21) Appl. No.: 18/647,272

(22) Filed: Apr. 26, 2024

(51) Int. Cl. H01H 50/64; H01H 50/02; H01H 50/44; H01H 50/54

(52) U.S. Cl. CPC H01H 50/641; H01H 50/02; H01H 50/44; H01H 50/54

(57) ABSTRACT

A contactor device includes a movable contact configured to selectively open/close an electrical circuit. The contactor device includes an actuator assembly having a shaft, a movable contact retention member, and a coupler coupling the shaft to the movable contact retention member. The movable contact retention member may be a single piece comprising a central portion, a first side portion, and a second side portion, and the first side portion and the second side portion are angled relative to the central portion.

### FIELD OF THE TECHNOLOGY

The subject disclosure relates to electrical switching devices, such as contactor devices and electrical fuse devices, and more particularly to carrier structures for movable contact elements for use with such devices and methods of making such structures.

### BACKGROUND OF TECHNOLOGY

Many conventional devices are known to selectively power on or off electrical devices. Electrical contactors, e.g., high-voltage DC contactors, and fuses, e.g., electrical fuses and/or pyrotechnic fuses, are conventionally available and used in electrical systems. Contactors may be configured to interrupt or complete a circuit to control electrical power to and/or from a device.

In many conventional systems, a contactor is configured as a switch, e.g., to selectively allow/disallow current flow. In some examples, one or more movable contacts may be coupled to a shaft, e.g., as a part of an actuator assembly. In these examples, the shaft may be movable, e.g., by an actuator, to selectively move the movable contact(s) into and out of contact with one or more fixed contacts. In some examples, the shaft (and the movable contact(s)) may be biased away from the fixed contact(s), e.g., to “open” the contactor and prevent current flow through the contactor. For example, a return spring may bias the shaft to an open position.

In some conventional arrangements, an actuator assembly can include the movable contact(s) be affixed to the shaft, e.g., directly to a distal end of the shaft. In other conventional actuator assembly arrangements, however, a carrier may be provided that couples the movable contact(s) to the shaft. In these latter examples, conventional carriers may be configured to fix the movable contact(s) relative to the shaft or may allow the movable contact(s) to move relative to the shaft, e.g., axially and/or rotationally about some defined path or in some defined space. While actuator assemblies that include carriers may provide improvements over directly-connected arrangements, conventional carrier designs may be difficult to manufacture and/or assemblies including such carriers may be difficult to assemble.

Accordingly, there is a need in the art for improved actuator assemblies, methods of manufacturing such assemblies, and methods of making devices including such assemblies. There also is a need in the art for improved devices with increased life spans and/or reduced complexity and/or cost.

### SUMMARY OF THE TECHNOLOGY

The subject technology relates to improved electrical devices and methods of making and using those devices. In examples, aspects of this disclosure relate to improved switching devices incorporating an actuator assembly that includes a carrier member coupling a movable contact to a shaft. In other examples, aspects of this disclosure relate to processes for manufacturing and/or assembling actuator assemblies and/or electrical devices incorporating such actuator assemblies.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1A is a perspective view of aspects of an actuator assembly including a shaft and a carrier, in accordance with aspects of this disclosure.

FIG. 1B is an inverted cross-sectional view of the actuator assembly of FIG. 1A, taken along section line B-B in FIG. 1A, in accordance with aspects of this disclosure.

FIG. 2 includes textual and graphical flow charts representative of a process for manufacturing and assembling an actuator assembly, in accordance with aspects of this disclosure.

FIG. 3 is a cross-sectional perspective view of an electrical device including an actuator assembly, in accordance with aspects of this disclosure.

FIG. 4 is a flow chart showing a process for manufacturing and assembling an electrical device, in accordance with aspects of this disclosure.

### DETAILED DESCRIPTION

The subject technology overcomes many of the prior art problems associated with electrical devices. In brief summary, the subject technology provides improved electrical devices including a contactor design that may have improved performance and/or longer functional life compared to other conventional electrical devices. In examples, the electrical device may have two discrete operation states, including a first operating state and a second operating state. In the first operation state, the device is open, e.g., such that no voltage or current flows through the device. In the second operating state, the device is closed. In examples, the electrical device can include a coil that is energized to cause one or more movable contacts to move into contact with one or more fixed or stationary contacts, thereby completing a circuit, e.g., to configure the device in the second operating state. In the second operating state, current, e.g., from a high voltage source, may flow through the device.

In aspects of this disclosure, the electrical device can include an actuator assembly that cooperates with a coil to selectively configure the electrical device in the first or second operating state, e.g., by cycling the movable contact relative to the fixed contact(s). For example, the actuator assembly may include the movable contact(s), a shaft, and a carrier member that couples the movable contact(s) to the shaft. In some example aspects of this disclosure, a carrier member can include a movable contact retention member and a coupler.

In some examples, the movable contact retention member can include a central portion, a first side portion extending from a first side of the central portion and a second side portion extending from a second side of the central portion, opposite the first side. The first side portion and the second side portion may be angled relative to the central portion. In some examples, the first side portion may be substantially parallel to the second side portion. Accordingly, in some examples, the movable contact retention member may be substantially U-shaped.

In aspects of this disclosure, the coupler couples to the movable contact retention member to the shaft. In some examples, the coupler can be molded over at least a portion of the shaft and a portion of the movable contact retention member to couple the shaft and the retention member. In at least some examples, the coupler can be formed of an insulative material, such as a polymer, e.g., to insulate the movable contact retention member from the shaft. To further facilitate this insulating, the coupler can couple the shaft to the movable contact retention member in a manner that separates the shaft from the movable contact retention member.

In aspects of this disclosure, the actuator assembly can also include a movable contact. For example, the carrier member according to this disclosure may be configured to receive the movable contact. In some instances, a first opening can be formed in the first side portion of the movable contact retention member, and a second opening can be formed in the second side portion of the movable contact retention member. The first opening and the second opening may be aligned, e.g., laterally, such that a movable contact can be passed through the openings.

The actuator assembly can also include a biasing spring. For example, the biasing spring may be a compression spring positioned between the coupler and the movable contact, to bias the movable contact away from the coupler. Aspects of this disclosure may facilitate simple association of the biasing spring with the coupler and/or the movable contact. For example, because the side portions of the movable contact retention member are spaced from each other, a gap is formed through which the biasing spring may be inserted into contact with the coupler.

Aspects of this disclosure also are directed to improved manufacturing and/or assembly processes for creating actuator assemblies and/or electrical devices. For example, techniques according to this disclosure can include providing a substantially planar movable contact retention member and a shaft, coupling the shaft to the contact retention member, and bending side portions of the movable contact retention member relative to the coupling. A biasing spring may then be placed between the bent, side portions and a movable contact can be inserted into openings in the side portions. Such processes may ease manufacturing, e.g., by requiring only a single bend at each of the side portions and/or allowing for coupling of parts with relatively simple geometries. Moreover, aspects of this disclosure can improve assembly processes, e.g., by providing a geometry that facilitates insertion of the biasing spring and/or the movable contact.

Without limitation, the devices and techniques described herein may provide improved electrical devices, which may be less complex, may be cheaper to manufacture and/or use, and/or that may have improved safety and/or result in improved system protection, when compared to similar conventional systems.

While aspects of this disclosure may be particularly useful in certain applications, like DC contactors for use in high voltage electrical systems, the systems and techniques described herein may be useful with any electrical devices that incorporate movable contact members.

Aspects of the disclosure will now be explained in more detail with reference to the Figures.

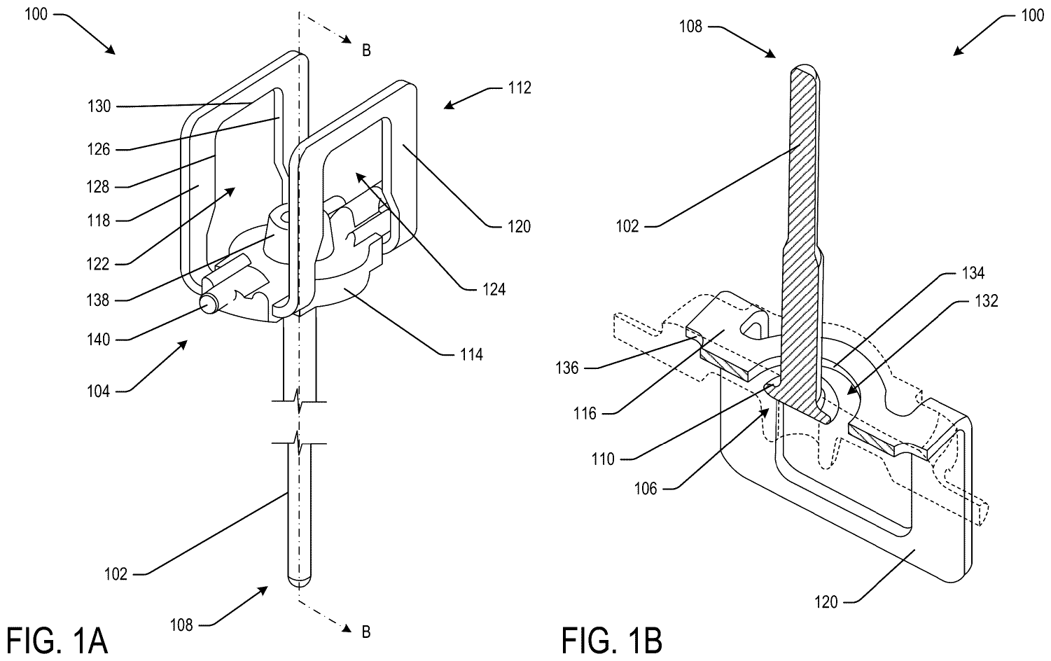

FIGS. 1A and 1B are views of a portion of an actuator assembly 100. More specifically, FIG. 1A is a perspective view of the portion of the actuator assembly 100 and FIG. 1B is an inverted, cross-sectional perspective view of the portion of the actuator assembly 100. As detailed further herein, the actuator assembly 100 is configured to, among other functions, facilitate selective opening and closing of an electrical device, e.g., by facilitating selective movement of a movable contact into and out of contact with fixed contacts.

As illustrated in FIGS. 1A and 1B, the actuator assembly 100 includes a shaft 102 and a carrier member 104 coupled to the shaft 102. In more detail, the shaft 102 is generally cylindrical and extends from a first end 106 (e.g., an upper end in the orientation of FIG. 1A) to a second end 108 (e.g., a lower end in the orientation of FIG. 1A) along an axis. As shown in FIG. 1B, the shaft 102 includes a flared head 110 at the first end 106. In examples, the flared head 110 may be desirable for attachment and/or securement of the carrier member 104 to the shaft, although in other examples, the flared head 110 may be differently shaped or may be omitted entirely.

Also in the example of FIG. 1B, the shaft 102 is illustrated as having a stepped profile, e.g. such that an outer diameter of the shaft 102 is different along an axial length of the shaft 102. For example, the shaft 102 is illustrated as having a relatively larger diameter proximate the first end 106 and a relatively smaller diameter proximate the second end 108. However, the illustrated configuration of the shaft 102 is for example only. In other examples, the shaft may have more or fewer steps/diameters and/or may be stepped at a different position along the axial length. Moreover, and without limitation, the shaft 102 may instead have a relatively larger diameter proximate the second end 108 than proximate the first end 106. In still further examples, the shaft 102 may have a substantially constant outer diameter along its axial length. Moreover, although the shaft 102 is illustrated as being substantially cylindrical, e.g., with a circular cross-section, other cross-sections may be used, including but not limited to cross-sections that are polygonal, arcuate, and/or other shapes. The configuration of the shaft 102 may be based at least in part on design aspects of an electrical device into which the actuator assembly 100 is to be incorporated.

The carrier member 104 is coupled to the shaft 102 proximate the first end 106. In more detail, FIGS. 1A and 1B show that the carrier member 104 includes a movable contact retention member 112 and a coupler 114 that retains the movable contact retention member 112 on the shaft 102.

The movable contact retention member 112 includes a central portion 116 (visible in FIG. 1B), a first side portion 118, and a second side portion 120. The first side portion 118 extends from a first side of the central portion 116, and the second side portion 120 extends from a second side of the central portion 116. As also illustrated, the first side portion 118 is angled relative to the central portion 116, and the second side portion 120 is angled relative to the central portion 116. In examples, the first side portion 118 and the second side portion 120 are angled relative to the central portion 116 such that they extend substantially parallel to each other and are spaced from each other, e.g., by a width of the central portion 116. Stated differently, the movable contact retention member 112 may be substantially U-shaped, with the central portion 116 forming a base of the “U” and the first and second side portions 118, 120 comprising “legs” of the “U.” As will be appreciated, this configuration of the movable contact retention member 112 defines an opening between the side portions 118, 120, which opening includes an opening between distal edges of the side portions 118, 120. As detailed further herein, the opening between the side portions 118, 120 may facilitate assembly of an electrical device including the carrier member 104.

The movable contact retention member 112 may be a metallic member, e.g., made of metal, a metal alloy, or the like. In at least some examples, the movable contact retention member 112 may be made from sheet metal. As discussed further herein, the movable contact retention member 112 may be formed as a generally planar member, e.g., cut, punched, or otherwise formed from sheet metal, and the first side portion 118 and the second side portion 120 may be subsequently bent relative to the central portion 116 to form the illustrated configuration.

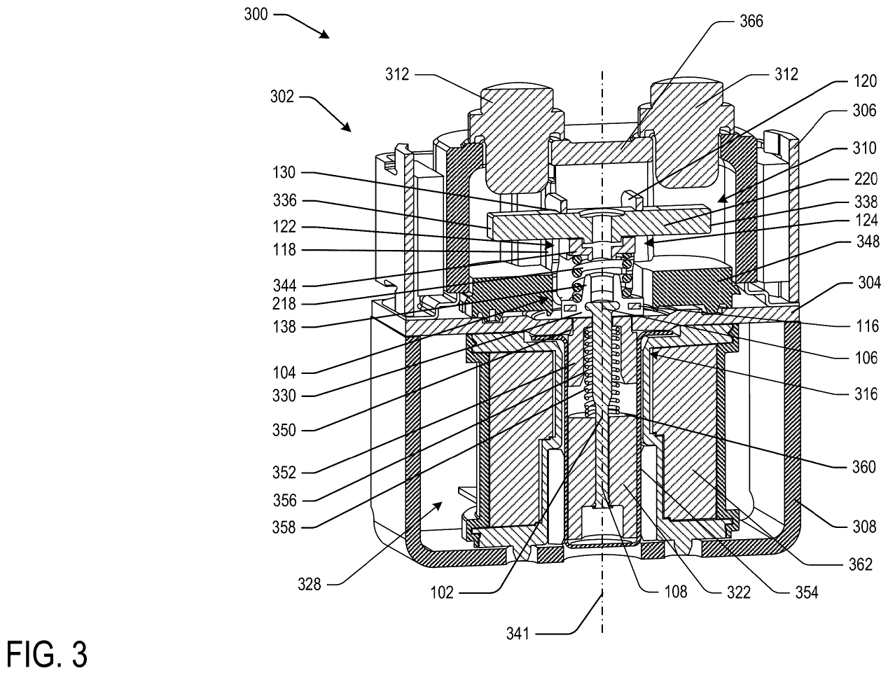

A first opening 122 is defined by the first side portion 118, and a second opening 124 is defined by the second side portion 120. The first opening 122 and the second opening 124 are generally aligned, e.g., along an axis normal to a longitudinal axis of the shaft 102. The openings 122, 124 are configured to retain a movable contact. FIG. 3, discussed below, shows that ends of a movable contact extend through the openings 122, 124. Specifically, the movable contact may be a substantially elongate or bar-shaped member extending from a first end to a second end. The movable contact extends through the openings 122, 124 in the spaced side portions 118, 120 such that the first end and the second end of the movable contact are disposed on opposite sides of the spaced side portions 118, 120.

In the example of FIG. 1A, the first opening 122 and the second opening 124 are substantially slot-shaped. The openings 122, 124 are defined at least in part by opposing faces 126, 128 that define a width of the openings 122, 124 and an upper face 130 that defines an upper (in the orientation of FIG. 1A) extent of the openings 122, 124. In examples, the opposing faces 126, 128 may be spaced to define a width that provides a clearance for a movable contact retained in the openings 122, 124. The upper face 130 may be provided to limit motion (e.g., upward motion) of the movable contact retained in the openings 122, 124 relative to the movable contact retention member 112. As illustrated, the upper face 130 may be substantially parallel to a distal edge of the respective one of the openings 122, 124 and/or be substantially perpendicular to the opposing faces 126, 128.

As illustrated in FIG. 1B, the movable contact retention member 112 can also include a central opening 132 formed through the central portion 116. In the example, the central opening 132 is a circular opening defined by a sidewall 134. The sidewall 134 defines a diameter of the central opening 132 that is larger than the first end 106 of the shaft (e.g., larger than a diameter of the flared head 110 of the shaft 102). As described further herein, the coupler 114 may be formed using a molding process, and the opening 132 (and the shaft 102) may be sized such that mold material may enter a space between the sidewall 134 and the shaft 102. Moreover, the spacing between the sidewall 134 and the shaft 102 may be determined to reduce, limit, or eliminate arcing or other electrical communication between the movable contact retention member 112 and the shaft 102, e.g., when both are conductive members.

In the example of FIG. 1B, the central portion 116 also includes notches 136. The notches 136 are illustrated as arcuate cutouts disposed at opposing edges of the central portion 116. The notches 136 may be present to reduce weight, reduce raw material usage, and/or for other reasons. The notches 136 illustrated are for example only. In other implementations, the notches 136 may be formed differently and/or at different positions. In still further examples, the notches 136 may be omitted.

The coupler 114 secures the movable contact retention member 112 to the shaft 102. In the illustrated example, the coupler 114 secures the movable contact retention member 112 to the first end 106 of the shaft 102. In examples of this disclosure, the coupler 114 may be an insulating coupler, e.g., that insulates the movable contact retention member 112 relative to the shaft 102. For example, when the movable contact retention member 112 is metallic, as discussed above, current flowing through the movable contact retained by the movable contact retention member 112 may be conducted by the movable contact retention member 112. Also in examples, the shaft 102 may be a metal shaft or may be otherwise conductive. The coupler 114 may thus be configured to insulate the movable contact retention member 112 from the shaft 102. Without limitation, the coupler 114 may be made of a polymeric material.

In examples, the coupler 114 may be molded onto the shaft 102. For instance, the coupler 114 may be a polymeric material formed on the shaft 102 via an overmolding process or the like. As noted above, the coupler 114 can be at least partially disposed in the central opening 132. For example, the coupler 114 may at least partially encapsulate a portion of the movable contact retention member 112, e.g., some or all of the central portion 116, and/or may at least partially encapsulate a portion of the shaft 102, e.g., a portion of the first end 106, such as the flared head 110 of the shaft 102. Although some examples may include molding or overmolding to affix the shaft 102 and the movable contact retention member 112, in other examples the components may be otherwise coupled. Without limitation, the coupler 114 may be separately formed and configured to attach to both the shaft 102 and the movable contact retention member 112, e.g., using one or more fasteners, fastening structures, attachment mechanisms, and/or the like.

The coupler 114 can also or alternatively include one or more additional features or components. For example, the coupler 114 is illustrated as including a tapered protrusion 138. The tapered protrusion 138 extends in a direction away from the central portion 116 of the movable contact retention member 112, e.g., into the space between the first side portion 118 and the second side portion 120 of the movable contact retention member 112. In examples, the tapered protrusion 138 may be provided to help maintain positioning and/or orientation of a biasing spring. For example, and as discussed further below in connection with FIG. 3, an outer diameter of the tapered protrusion 138 may be similar to or slightly smaller than an inner diameter of a biasing spring, e.g., to seat the biasing spring and/or to limit or prevent lateral movement of the biasing spring relative to the coupler 114.

In still further examples, the coupler 114 may incorporate one or more alignment features. The alignment features may be provided to maintain a desired rotational orientation of the coupler 114, and thus of the movable contact retention member 112 and/or other aspects of the actuator assembly 100. For instance, the example of FIG. 1 shows that the coupler 114 includes two posts 140 extending laterally from the coupler 114. Although not shown in the Figures, the posts 140 may be configured to be received in corresponding slots or grooves formed within an electrical device with which the actuator assembly 100 is used. When the posts 140 extend generally horizontally, as in the orientation of FIG. 1A, the posts 140 may be configured to be received in corresponding vertical slots or grooves. Such an arrangement will allow for movement of the shaft 102 generally axially along an axis of the shaft 102, but the arrangement will restrict rotational motion of the shaft 102.

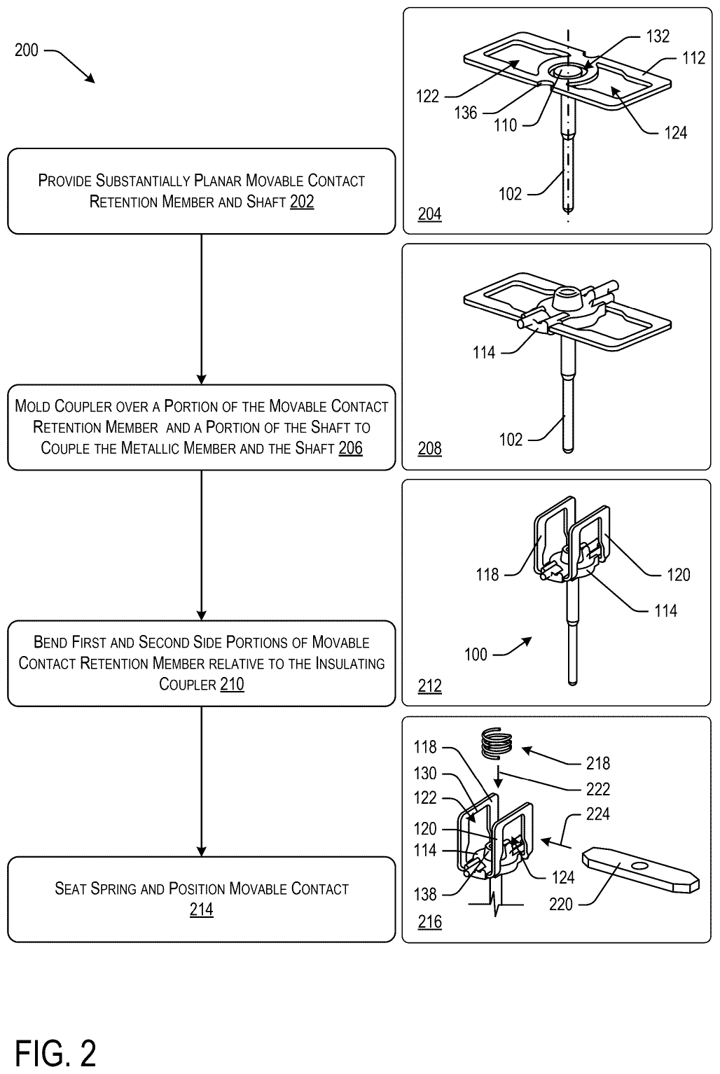

FIG. 2 includes textual and pictorial flowcharts describing and showing a process 200 of manufacturing an actuator assembly, like the actuator assembly 100, for use in an electrical device. In FIG. 2, features that were introduced above in connection with FIG. 1 are labeled with the same reference numerals.

At an operation 202, the process 200 includes providing a substantially planar movable contact retention member and a shaft. In the example 204 accompanying the operation 202, the shaft 102 and the movable contact retention member 112 are illustrated. In the example 204, the movable contact retention member 112 is substantially planar. For example, the movable contact retention member 112 may be made from a sheet of material, such as sheet metal. In examples, the movable contact retention member 112 may be stamped, cut, or otherwise formed. In the example 204, the movable contact retention member 112 is substantially rectangular, and includes the first opening 122, the second opening 124, the central opening 132, and the optional notches 136.

The example 204 also shows the shaft 102. Specifically, the shaft 102 is illustrated as being arranged such that the flared head 110 is positioned in the central opening 132 of the movable contact retention member 112. As will be appreciated, the shaft 102 may be otherwise disposed relative to the movable contact retention member 112. For example, the shaft may be disposed relatively higher or lower (in the orientation of the example 204) than illustrated. Any relative position that situates the shaft 102 and the movable contact retention member 112 proximate each other for coupling may be used.

At an operation 206, the process 200 includes molding a coupler over a portion of the movable contact retention member and a portion of the shaft to couple the metallic member and the shaft. An example 208 accompanying the operation 206 shows the coupler 114 discussed above. The coupler 114 may be molded, e.g., as an overmold. For instance, the shaft 102 and the movable contact retention member 112 may be maintained in their relative positions illustrated in the example 204 and a mold may be placed around at least a portion of the shaft 102 and the movable contact retention member 112. A mold material, e.g., liquid polymer, may then be introduced into the mold. The mold material may enter the central opening 132, e.g., into the space between the flared head 110 and the sidewall 134 of the central opening 132, and/or may otherwise be positioned around portions of the shaft 102 and the movable contact retention member 112. Upon curing, the mold may be removed, leaving the coupler 114, as shown in the example 208.

According to aspects of this disclosure, the coupler 114 may be a polymeric or other material that insulates the shaft 102 from the movable contact retention member 112. However, different materials, such as conductive materials, may be used, e.g., if the shaft 102 and/or the movable contact retention member 112 are not conductive and/or if conducting electricity is otherwise not a concern. As will be appreciated, because the movable contact retention member 112 is substantially planar, the process of creating the coupler 114 may be more readily accomplished, e.g., compared to the member 112 having a more complex or bent shape.

At an operation 210, the process 200 includes bending first and second side portion of the movable contact retention member relative to the insulating coupler. An example 212 accompanying the operation 210 shows that the first side portion 118 and the second side portion 120 are bent relative to the coupler 114. The example 212 shows the actuator assembly 100 of FIGS. 1A and 1B. In examples, the movable contact retention member 112 can include one or more features to facilitate the bending of the operation 210. For instance, and without limitation, the movable contact retention member 112 can include score marks or other features at positions at which the bending should be performed.

At an operation 214, the process 200 includes seating a bias spring and positioning a movable contact. The operation 214 includes additional assembly steps taken after forming the portion of the actuator assembly 100 shown in example 212. Aspects of the portion of the actuator assembly 100 may be particularly suited to simplify assembly.

The example 216 accompanying the operation 214 shows a biasing spring 218 and a movable contact 220. As illustrated, the biasing spring 218 may be inserted generally axially into the opening between the first side portion 118 and the second side portion 120. The separation between the side portions 118, 120, and the absence of a bridge or other connecting member spaced from the coupler 114 allows for ready insertion of the biasing spring, generally along the direction of arrow 222. The biasing spring 218 may be seated on the tapered protrusion 138, when the tapered protrusion 138 is provided. As also shown in the example 216, the movable contact 220 may be inserted laterally through the first opening 122 formed in the first side portion 118 and through the second opening 124 formed in the second side portion 120. For example, the movable contact 220 may be inserted generally along the direction of arrow 224. Once inserted, and as illustrated in FIG. 3, discussed below, the biasing spring 218 is positioned between the coupler 114 and the movable contact 220, e.g., to bias the movable contact 220 away from the coupler 114 and against the upper face 130.

According to the process 200, aspects of this disclosure may provide an improved manufacturing and assembling process that provides for a single bending operation, e.g., to bend the first and second side portions 118, 120 relative to the central portion 116. Moreover, because the movable contact retention member 112 is formed from a continuous piece, e.g., a continuous piece of steel, strength of the resultant actuator assembly 100 may be increased and/or retention within the overmolded coupler 114 may be increased. In addition, because the movable contact retention member 112 is formed as a planar member, the member 112 can be formed using operations such as stamping, die-cutting, or the like, which may improve dimensional precision/control. Moreover, because a gap is provided between the first side portion 118 and the second side portion 120, the biasing spring 218 can be readily “dropped” or placed into position, which may be simplify assembly, such as high volume automated assembly.

FIG. 3 is a cross-sectional view of an electrical device 300 incorporating the actuator assembly 100 discussed above. In examples of this disclosure, the electrical device 300 may be a switch or contactor assembly, such as a DC contactor. In other examples, the electrical device may be a hybrid device, e.g., that includes a fuse or disconnect (such as a pyrotechnic disconnect). As will be appreciated from this disclosure, aspects of this disclosure may be incorporated into any electrical device that incorporates one or more movable contacts.

In the illustrated example, the electrical device 300 includes an electrical device housing 302. The housing 302 includes a housing base 304 disposed between an upper housing portion 306 and a lower housing portion 308. In the example of FIG. 3, the upper housing portion 306 is configured to cooperate with the housing base 304. In examples, the switch assembly housing base 304 and portions of the upper housing portion 306 may be metal parts, e.g., steel parts, welded to each other. In other examples, portions of the upper housing portion 305 can be ceramic, polymeric, or formed of other materials. The upper housing portion 306 defines, at least in part, an upper housing volume 310. In some examples, the upper housing volume 310 may be a hermetically-sealed volume. An electronegative gas may be contained in the upper housing volume 310. This hermetically sealed configuration can help mitigate or prevent electrical arcing between adjacent conductive elements, and in some embodiments, may help provide electrical isolation between conductive contacts, as detailed further herein. In some examples, the upper housing volume 310 can be under vacuum conditions, and can be hermetically sealed using known means of generating hermetically sealed electrical devices.

Features of the electrical device 300 are disposed in the upper housing volume 310. For example, the view of FIG. 3 shows two fixed contacts 312 coupled to the upper housing portion 306. The fixed contacts 312 are disposed partially in the upper housing volume 310 and are configured to electrically connect internal components (detailed further herein) of the electrical device 300 to external circuitry, for example, to an electrical system or device. For example, the fixed contacts 312 may be terminals configured to facilitate connection of first electrical leads (not shown) from a voltage source to second electrical leads (also not shown) associated with a load to be powered by the voltage source.

The electrical device 300 also includes the movable contact 220. The movable contact 220 is movable between a first position spaced from the fixed contacts 312 and a second position contacting the fixed contacts 312. The first position is shown in FIG. 3, and the movable contact 220 may be moved upward (in the orientation of FIG. 3) from the illustrated position to the second position. In the illustrated example, the movable contact 220 is a generally elongate member that, in the second position, not illustrated but just described, can simultaneously contact both of the fixed contacts 312. Accordingly, the movable contact 220 can selectively couple the two fixed contacts 312, to facilitate current flow between the fixed contacts 312 and thus through the electrical device 300.

The electrical device 300 also includes an actuator assembly 316 configured to, among other functions, facilitate selective opening and closing of the electrical device 300, e.g., by facilitating selective movement of the movable contact 220 into and out of contact with the fixed contacts 312. In examples, the actuator assembly 316 can include the movable contact 220 and/or may be operatively coupled to the movable contact 220. The actuator assembly 316 can be the same as, include, or otherwise be associated with the portion of the actuator assembly 100 discussed above.

As illustrated in FIG. 3, the actuator assembly 316 is illustrated as including the shaft 102, the carrier member 104, and a plunger 322.

In the example, the shaft 102 is disposed such that the first end 106 (e.g., an upper end in the orientation of FIG. 3) is positioned in the upper housing volume 310 defined by the upper housing 306 and the base 304. The first end 106 is coupled to the movable contact 220, e.g., via the coupler 114, as discussed above. The opposite, second end 108 of the shaft 102 extends through the base 304 into a lower housing volume 328 defined at least in part by the lower housing portion 308. The second end 108 of the shaft 102 is coupled to the plunger 322.

FIG. 3 shows that the carrier member 104 includes the coupler 114 and the opposing spaced first and second side portions 118, 120 extending upward (in the orientation of FIG. 3) from the coupler 114. In this example, the opposing side portions 118, 120 define the respective openings 122, 124 through which portions of the movable contact 220 extend. Specifically, the movable contact 220 is a substantially elongate or bar-shaped member extending from a first end 336 to a second end 338. The movable contact 220 extends through the openings 122, 124 in the spaced side portions 118, 120 such that the first end 336 and the second end 338 are disposed on opposite sides of the spaced side portions 118, 120 of the carrier member 104 (and generally aligned vertically with the fixed contacts 312).

In the illustrated example, the coupler 114 of the carrier member 104 is secured to the first end 106 of the shaft 102. As described herein, the coupler 114 may be molded onto the first end 106 of the shaft 102 and onto at least a portion of the central portion 116 of the movable contact retention member 112. For instance, the coupler 114 may be a polymeric material formed on the shaft 102 via an overmolding process or the like. In examples, the polymeric material may configure the base to electrically isolate the movable contact 220 from the remaining actuator components (e.g., the shaft 102) and/or portions of the housing 302 (e.g., the base 304). As noted above, the coupler 114 can also incorporate one or more additional features. However, the side portions 118, 120 may be otherwise coupled, secured, or attached to the coupler 114 in other examples.

As discussed above, the side portions 118, 120 define the openings 122, 124 which provide clearance for the ends 336, 338 of the movable contact 220. The movable contact 220 may be movable, e.g., vertically in the orientation of FIG. 3, in the openings 122, 124 relative to the side portions 118, 120 and the coupler 114.

FIG. 3 also illustrates the biasing spring 218 is disposed between the coupler 114 and the movable contact 220. More specifically, the biasing spring 218 biases the movable contact 220 away from the shaft 102 and against the upper faces 130 of the openings 122, 124 in the side portions 118, 120. Thus, in the illustrated example, the shaft 102 is secured to the carrier member 104 (e.g., to the coupler 114 of the carrier member 104) and the biasing spring 218 biases the movable contact 220 against the upper faces 130 of the openings 122, 124 in the side portions 118, 120 of the carrier member 104. Accordingly, movement of the shaft 102, e.g., along an axis 341 of the shaft 102, will cause corresponding movement of the carrier member 104, the biasing spring 218, and the movable contact 220. For example, when the shaft 102 is caused to move downward in the orientation of FIG. 3, the movable contact 220 moves away from the fixed contacts 312. Alternatively, when the shaft 102 is caused to move upward in the orientation of FIG. 3, the movable contact 220 is moved toward, and eventually into contact with, the fixed contacts 312. Continued movement of the shaft 102 in the upward direction (in the orientation of FIG. 3) when the movable contact 220 contacts the fixed contacts 312, can result in continued travel of the carrier member 104 relative to the movable contact 220, e.g., resulting from compression of the biasing spring 218. In this example, the biasing spring 218 can compensate for overtravel of the shaft 102, e.g., to prevent destructive contact of the movable contact 220 with the fixed contacts 312.

FIG. 3 also shows that the coupler 114 of the carrier member 104 includes the tapered protrusion 138. As described above, the protrusion 138 may be provided to help maintain positioning and/or orientation of the biasing spring 218. For example, an outer diameter of the protrusion 342 may be similar to or slightly smaller than an inner diameter of the biasing spring 218, e.g., to limit or prevent lateral movement of the biasing spring 218 relative to the carrier member 104.

FIG. 3 also shows a lower yoke 344 disposed below and in contact with the movable contact 220. In examples, the lower yoke 344 may be a metal component configured to cooperate with an upper yoke 346 to provide a metallic or conductive “ring” around the movable contact 220 when the movable contact 220 contacts the fixed contacts 312. For example, the lower yoke 344 and the upper yoke 346 may cooperate to enhance or control an electromagnetic field generated by current passing through the movable contact 220. In the example, the upper yoke 346 is coupled to the upper housing 306, e.g., such that the shaft 102, the movable contact 220, the carrier member 104, and the lower yoke 344 (e.g., the actuator assembly 316) move relative to the upper yoke 346. In other examples, however, the upper yoke 346 may be coupled to the movable contact 220 and/or to the lower yoke 344. In still further examples, one or both of the yokes 344, 346 may not be provided.

FIG. 3 also shows an arc shield member 348. The arc shield member 348 may be a polymeric or other insulative material that acts as an insulator or barrier, e.g., in case of arcing in the upper housing volume 310 or the like. In the illustrated example, the arc shield 348 is disposed on the housing base 304 and defines an opening that generally surrounds a portion of the actuator assembly 316, e.g., the carrier member 104. In some examples the arc shield member 348 may incorporate an alignment feature that cooperates with an alignment feature on the actuator assembly 316, such as the posts 140 discussed above. In other examples, the arc shield member 348 can include additional features, such as retainers for retaining the movable contact 220 in a position spaced from the fixed contacts 312. In still further examples, the arc shield member may not be provided.

The configuration of FIG. 3 is provided for example only. For example, modifications to the actuator assembly 316 are contemplated and will be appreciated by those having ordinary skill in the art with the benefit of this disclosure. For example, the lower yoke 344 and/or the upper yoke 346 may be omitted. Also, in some examples, aspects of the carrier member 104 may be omitted.

As also shown in FIG. 3, the shaft 102 extends through the base plate 304, such that the second end 108 of the shaft 102 is disposed in the lower volume 328, defined at least in part by the lower housing portion 308. In the illustrated example, an opening 350 or hole is formed in the base 304, and the shaft 102 extends through the opening 350. In the illustrated example, the opening 350 is sized to have a diameter smaller than an outer extent of the carrier member 104 (e.g., the coupler 114 of the carrier member 104) such that the carrier member 104 contacts the base 304 and does not pass through the opening 350. Also in the illustrated example, an alignment plug 352 is disposed at least partially in the opening 350. The alignment plug 352 may be configured for fitting into the opening 350, e.g., via a press fit. When present, the alignment plug 352 also defines an opening through which the shaft 102 extends.

When used, the alignment plug 352 may facilitate locating one or more additional components of the electrical device 300. For example, the alignment plug 352 extends from the opening 350 (and the base 304) into the lower volume 328. In the illustrated example, a distal end (e.g., spaced from the base 304) of the alignment plug 352 is sized to extend into a plunger tube 354. For example, an inner diameter of the plunger tube 354 and an outer diameter of the alignment plug 352 may be sized to allow for the alignment plug 352 to be disposed in the plunger tube 354. In some examples, the alignment plug 352 can be press fit into the plunger tube 354 (or the plunger tube 354 can be press fit over the alignment plug 352). As detailed further below, the plunger tube 354 can house or otherwise retain the plunger 322.

As also illustrated in FIG. 3, the alignment plug 352 may also define a bore 356. The shaft 102 passes through the bore 356. Moreover, the bore 356 is sized to receive at least a portion of a return spring 358. In the example, the return spring 358 is a compression spring extending from a first end disposed in the bore 356 (and contacting an inner, bottom surface of the bore 356) of the alignment plug 352 to a second end spaced from the first end along an axis of the return spring 358. The second end of the return spring 358 contacts an upper surface 360 of the plunger 322. In the illustrated example, because the alignment plug 352 is fixed to the base 304 of the housing 302, the return spring 358 biases the plunger 322 away from the base 304, e.g., in a downward direction in the orientation of FIG. 3. Moreover, because the second (e.g., lower) end 108 of the shaft 102 also is coupled to the plunger 322, the return spring 358 biases the shaft 102 and the movable contact 220, e.g., away from the fixed contacts 312.

The actuator assembly 316 is driven by a coil 362, e.g., a DC coil. The coil 362 may be selectively energized. For example, and as shown in FIG. 3, the coil 362 is disposed proximate the plunger tube 354. In examples, the coil 362 is a cylindrical coil that is disposed around the plunger tube 354. The plunger 322 is disposed in the plunger tube 354, and the plunger 322 is movable relative to the plunger tube 354. In examples, the plunger tube 354 may be fixed relative to the coil 362 and the plunger 322 is free to move axially relative to the plunger tube 354 (and the coil 362) in response to activation/deactivation of the coil 362. As detailed above, the plunger 322 is coupled to the second end 108 of the shaft 102. The return spring 358 is positioned on the shaft 102 between the upper surface 360 of the plunger 322 and a lower surface of the housing base 304 (e.g., the alignment plug 352 in FIG. 3). The return spring 358 biases the plunger 322 (and thus the shaft 102) away from the base 304, e.g., in a downward direction in FIG. 3 along the axis 341. Accordingly, when the coil 362 is not charged, the return spring 358 biases the shaft 102 (via the plunger 322) to distance the movable contact 220 from the fixed contacts 312.

In examples, the coil 362, plunger 322 and/or other components described herein may form a part of a low voltage electrical system, whereas the fixed contacts 312 and the movable contact 220 may be part of a high voltage electrical system. Accordingly to aspects of this disclosure, the coupler 114 may electrically isolate these two electrical systems.

The example of FIG. 3 shows a normally open contactor, e.g., such that the return spring 358 biases the movable contact 220 away from the fixed contacts 312, and the plunger is actuated against a biasing force of the return spring 358 to close the circuit (e.g., by contacting the movable contact 220 to the fixed contacts 312). Aspects of this disclosure may also be applied to other contactor constructions, including normally closed contactors. In a normally closed contactor, the return spring 358 may bias the movable contact toward the fixed contacts 312 and the plunger is actuated against the biasing force of the return spring 358 to open the circuit (e.g., by separating the movable contact 220 from the fixed contacts 312). Aspects of this disclosure can be incorporated into any electrical device that includes a movable contact.

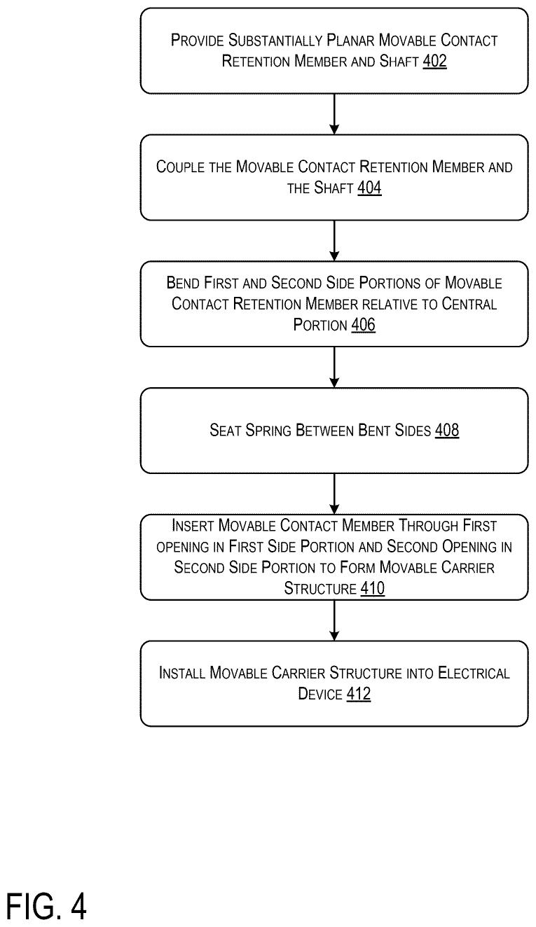

FIG. 4 is a flow chart describing a process of manufacturing an electrical device, like the electrical device 300, according to aspects of this disclosure.

At an operation 402, the process 400 includes providing a substantially planar movable contact retention member and a shaft. In examples, the operation 402 may be substantially the same as the operation 202 discussed above. For example, the operation 402 can include providing the shaft 102 and the movable contact retention member 112. The movable contact retention member may be substantially planar, e.g., formed from a sheet material, such as sheet metal.

At an operation 404, the process 400 includes coupling the movable contact retention member and the shaft. For example, the operation 402 can include coupling the shaft 102 to the movable contact retention member 112. In some instances, the operation 404 can include overmolding a mold material over a portion of the shaft 102 and a portion of the movable contact retention member 112. In other examples, other types of couplers may be used to implement the operation 404. Without limitation, the operation 404 may correspond to the operation 206 discussed above in connection with FIG. 2.

At an operation 406, the process can include bending first and second side portions relative to a central portion of the movable contact retention member. For example, the operation 406 can include bending the first side portion 118 and the second side portion 120 relative to the central portion 116 of the movable contact retention member 112. As detailed herein, each of the side portions 118, 120 can be bent with a single bending operation. This may be different from some conventional applications, in which multiple bends and bending operations are required to form more complex bent parts. Without limitation, the operation 406 may correspond to the operation 210 discussed above in connection with FIG. 2.

At an operation 408, the process 400 includes seating a spring between the bent sides. For example, and as detailed herein, because the side portions 118, 120 are separate and define a gap or opening, a biasing spring may be inserted into a position between the side portions 118, 120. The biasing spring may be the biasing spring 218.

At an operation 410, the process 400 includes inserting a movable contact member through a first opening in the first side portion and a second opening in the second side portion to form a movable carrier structure. For example, and as discussed herein, the first and second side portions 118, 120 can include respective first and second openings 122, 124. At the operation 410, a movable contact, like the movable contact 220 can be passed through the openings 122, 124, e.g., via a lateral insertion, to position the biasing spring 218 between the movable contact 220 and the coupler 114. Without limitation, the operations 408, 410 may correspond to the operation 214 discussed above in connection with FIG. 2.

At an operation 412, the process 400 includes installing the movable carrier structure into an electrical device. For example, the operation 412 can include passing the shaft 102 through the opening 350 and/or the bore 356 discussed above to position the movable contact 220 and the carrier assembly 104 in the upper housing volume 310 and the second end 108 of the shaft 102 in the lower housing volume 328. Once in position, the plunger 322 may be secured to the shaft 102 and the plunger tube 354 may be positioned over the plunger 322 and shaft 102. Of course, this is for example only. The operation 412 can include any operations or steps used to assemble, manufacture, or otherwise integrate the movable carrier structure into the electrical device.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A switching device comprising:
a housing defining a volume;
one or more fixed contacts disposed at least partially in the volume defined by the housing;
a movable contact disposed in the volume; and
an actuator assembly configured to move the movable contact, the actuator assembly comprising:
a shaft, and
a carrier member coupling the movable contact to the shaft, the carrier member comprising:
a movable contact retention member including a central portion, a first side portion extending from a first side of the central portion and a second side portion extending from a second side of the central portion, opposite the first side, wherein the first side portion and the second side portion are angled relative to the central portion and the first side portion is substantially parallel to the second side portion; and
a coupler coupling the central portion and the shaft.

2. The switching device of claim 1, wherein:
the movable contact retention member is metallic; and
the coupler insulates the movable contact retention member from the shaft.

3. The switching device of claim 1, wherein:
a first distal edge of the first side portion spaced from the central portion is spaced from a second distal edge of the second side portion spaced from the central portion; and
the spacing defines an open top of the carrier member.

4. The switching device of claim 1, wherein
the shaft has a head;
the central portion of the movable contact retention member comprises a hole sized to provide a clearance for the head with the head disposed at least partially in the hole; and
the coupler extends into the clearance between the head and the hole.

5. The switching device of claim 1, wherein:
the first side portion defines a first opening;
the second side portion defines a second opening; and
the movable contact is disposed such that a first end of the movable contact extends through the first opening and a second end of the movable contact extends through the second opening.

6. The switching device of claim 1, further comprising:
a biasing spring disposed between the first side portion and the second side portion and biasing the movable contact away from coupler.

7. The switching device of claim 6, wherein the coupler comprises a protrusion and the biasing spring is disposed over the protrusion.

8. The switching device of claim 1, wherein the coupler is at least one of made of a polymeric material or is an overmold disposed over a portion of the shaft and a portion of the central portion of the movable contact retention member.

9. The switching device of claim 1, wherein:
the movable contact retention member comprises sheet metal; and
the first side portion and the second side portion are bent relative to the central portion.

10. The switching device of claim 1, further comprising:
a plunger coupled to a distal end of the shaft; and
a coil disposed proximate the plunger and selectively energized to move the plunger along an axial direction relative to the coil.

11. An actuator assembly for use with an electrical device, the actuator assembly comprising:
a shaft;
a movable contact retention member comprising a central portion, a first side portion extending from a first side of the central portion and a second side portion extending from a second side of the central portion, opposite the first side, wherein the first side portion and the second side portion are angled relative to the central portion and the first side portion and the second side portion are substantially parallel to each other; and
a coupler coupling the central portion and the shaft.

12. The actuator assembly claim 11, wherein:
the shaft has a head;
the central portion of the movable contact retention member comprises a hole sized to provide a clearance for the head with the head disposed at least partially in the hole; and
the coupler extends into the clearance between the head and the hole.

13. The actuator assembly of claim 11, wherein:
the first side portion defines a first opening;
the second side portion defines a second opening; and
the first opening and the second opening are configured to receive a movable contact.

14. The actuator assembly of claim 13, further comprising:
a biasing spring disposed between the first side portion and the second side portion and biasing the movable contact away from coupler.

15. The actuator assembly of claim 11, wherein:
the movable contact retention member comprises sheet metal; and
the first side portion and the second side portion are bent relative to the central portion.

16. A method of manufacturing an actuator assembly for use in an electric device, the method comprising:
providing a substantially planar movable contact retention member comprising a central portion, a first side portion extending from a first side of the central portion, and a second side portion extending from a second side of the central portion, the second side being opposite the first side;
providing a shaft;
coupling the substantially planar movable contact retention member to the shaft with a coupler; and
after the coupling the substantially planar movable contact retention member to the shaft, bending the first side portion relative to the central portion and bending the second side portion relative to the central portion.

17. The method of manufacturing of claim 16, wherein:
the coupling the substantially planar movable contact retention member to the shaft comprises molding the coupler as a polymeric mold over a portion of the substantially planar movable contact retention member and a portion of the shaft.

18. The method of manufacturing of claim 16, further comprising:
disposing a biasing spring on the coupler to extend from the coupler between the first side portion and the second side portion; and
positioning a movable contact such that the biasing spring biases the movable contact away from the coupler.

19. The method of manufacturing of claim 18, wherein:
the positioning the movable contact comprises inserting a movable contact into a first opening defined by the first side portion and a second opening defined by the second side portion such that a first end of the movable contact extends from the first side portion and a second end of the movable contact extends from the second side portion.

20. The method of manufacturing of claim 19, further comprising:
inserting the actuator assembly into the electrical device such that the shaft is movable between a first position in which the movable contact contacts fixed contacts and a second position in which the movable contact is spaced from the fixed contacts.
